(19) United States
(12) Patent Application Publication
(10) Pub. No.: US 2013/0111710 A1
(43) Pub. Date: May 9, 2013

(54) MULTI-POLE MAGNETIC CONNECTOR APPARATUS

(71) Applicant: Larry Dean Hunts, Dongguan (CN)

(72) Inventor: Larry Dean Hunts, Dongguan (CN)

(73) Assignee: SPARKLING SKY INTERNATIONAL LIMITED, Wan Chai (HK)

(21) Appl. No.: 13/297,953

(22) Filed: Nov. 16, 2011

Related U.S. Application Data
(60) Provisional application No. 61/555,392, filed on Nov. 3, 2011.

(51) Int. Cl. H01F 7/02

(52) U.S. Cl. 24/303

(57) ABSTRACT

A universal connector apparatus may comprise a connection member having one or more connection edges. One or more multi-pole magnetic assemblies may be rotatably secured adjacent one or more of the connection edges. Each multi-pole magnetic assembly may be configured to rotate about a longitudinal axis in order to align opposite polarities and magnetically link the respective connection edge with a connection edge of another connector apparatus or other magnetic form. According to various embodiments, each multi-pole magnetic assembly may include a first half and a second half extending along a longitudinal axis. The first half may include a plurality of magnetic sections of alternating polarities and the second half may include a corresponding number of magnetic sections each having a polarity opposite that of an adjacent magnetic section in the first half.

### RELATED APPLICATIONS

The present application claims the benefit under 35 U.S.C. §119(e) of U.S. Provisional Patent Application No. 61/555,392 filed Nov. 3, 2011 and titled “MULTI-POLE MAGNETIC CONNECTOR APPARATUS,” which application is incorporated herein by reference in its entirety.

### TECHNICAL FIELD

This disclosure relates to magnetic connectors. More particularly, this disclosure relates to magnetic connectors configured to rotate in order to magnetically link two objects.

### BRIEF DESCRIPTION OF THE DRAWINGS

Non-limiting and non-exhaustive embodiments of the disclosure are described, including various embodiments of the disclosure with reference to the figures, in which:

FIG. 1A illustrates a multi-pole magnetic assembly configured with four magnetic sections of alternating polarities.

FIG. 1B illustrates a multi-pole magnetic assembly configured with eight magnetic sections of alternating polarities.

FIG. 1C illustrates a multi-pole magnetic assembly configured with N magnetic sections of alternating polarities.

FIG. 2 illustrates a multi-pole magnetic assembly configured with six magnetic sections of alternating polarities, including relatively larger center sections.

FIG. 3A illustrates a multi-pole magnetic assembly configured with eight magnetic sections of alternating polarities in an oblong configuration.

FIG. 3B illustrates a multi-pole magnetic assembly configured with six magnetic sections of alternating polarities in a rectangular prism configuration.

FIG. 4 illustrates a cylindrical multi-pole magnetic assembly encased within a cylindrical enclosure.

FIG. 5 illustrates a rectangular prismic multi-pole magnetic assembly encased within a cylindrical enclosure.

FIG. 6 illustrates a cylindrical multi-pole magnetic assembly encased within a triangular prismic enclosure.

FIG. 7A illustrates a connector apparatus including two cylindrical multi-pole magnetic assemblies configured to rotatably align polarities in order to magnetically link two sections of a fabric.

FIG. 7B illustrates a connector apparatus including two cylindrical multi-pole magnetic assemblies with aligned polarities magnetically linking the two sections of fabric.

FIGS. 8A-8B illustrate a first multi-pole magnetic assembly rotating about a longitudinal axis to align the polarities of its magnetic sections with those of a second multi-pole magnetic assembly.

FIGS. 8C-8D illustrate the first multi-pole magnetic assembly rotating about its longitudinal axis in order to magnetically link with the second multi-pole magnetic assembly longitudinally askew along an outer perimeter.

FIGS. 9A-9G illustrate a first multi-pole magnetic assembly and a second multi-pole magnetic assembly rotatably interacting and maintaining a magnetic link while the second multi-pole magnetic assembly is longitudinally translated along the outer perimeter of the first multi-pole magnetic assembly.

FIG. 10A illustrates a connection member including three connection edges forming a triangular framework, including a multi-pole magnetic assembly adjacent each connection edge.

FIG. 10B illustrates a connection member including three connection edges forming a triangular framework, including a magnetic assembly and enclosure combination adjacent each connection edge.

FIG. 10C illustrates a connection member including three connection edges in a triangular configuration, including a magnetic assembly and enclosure combination adjacent each connection edge.

FIG. 10D illustrates a connection member including three connection edges in a triangular framework, including a rotatable multi-pole magnetic assembly adjacent each connection edge.

FIG. 11 illustrates a connection member including three connection edges in a triangular configuration, each connection edge including a cylindrical enclosure encasing a rectangular prismic multi-pole magnetic assembly.

FIG. 12 illustrates a connection member including six connection edges in a hexagonal configuration, including a magnetic assembly and enclosure combination encased adjacent each connection edge.

FIG. 13A illustrates a first connector apparatus including a first connection member having four connection edges arranged in a rectangular configuration, and a second connector apparatus having four connection edges arranged in a rectangular configuration.

FIG. 13B illustrates the first and second connector apparatus magnetically linked along aligned outer perimeters.

FIGS. 14A-14B illustrate a multi-pole magnetic assembly adjacent a connection edge of a connection member rotating in order to magnetically link with a second connector apparatus along askew outer perimeters.

FIGS. 15A-15B illustrate first and second connector apparatus magnetically linking along askew outer perimeters.

FIG. 16A illustrates a connector apparatus including a rectangular connection member in the process of being magnetically linked to four triangular connection members, including rotatable magnetic assembly and enclosure combinations adjacent each connection edge of each connection member.

FIG. 16B illustrates the connector apparatus including a rectangular connection member magnetically linked to four triangular connection members, the magnetic assembly and enclosure combinations rotated such that opposite polarities are aligned.

FIG. 17 illustrates a connector apparatus comprising four triangular connection members, including rotatably aligned magnetic assembly and enclosure combinations magnetically linking each connection edge of the four triangular connection members in order to form a tetrahedron.

FIG. 18A illustrates a magnetizing apparatus configured with a bottom plate and a hinged top plate configured to create a multi-pole magnetic assembly.

FIG. 18B illustrates the magnetizing apparatus with two magnetizable cylinders in place.

FIG. 18C illustrates a multi-pole magnetic assembly created using the magnetizing apparatus.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

A universal connector apparatus as described herein may include two or more multi-pole magnetic assemblies configured to rotate with respect to one another in order to align opposite polarities and magnetically link two or more components. According to various embodiments, a multi-pole magnetic assembly may be cylindrical, rectangular, prismic, and/or oblong. Alternative shapes are contemplated as well. A multi-pole magnetic assembly may include any number of magnetic sections, each adjacent magnetic section having an alternating polarity. Magnetic assemblies may be encased within an enclosure, such as a cylindrical or triangular prismic enclosure. Alternatively, magnetic assemblies may be otherwise affixed to a connection member or another component of the connector apparatus. For example, a rod may be positioned to extend through a central axis of one or more magnetic assemblies to facilitate the rotation.

In some embodiments, the multi-pole magnetic assembly may be configured to rotate within and with respect to the enclosure. In alternative embodiments, the enclosure encasing the multi-pole magnetic assembly is configured to rotate. Enclosures and/or magnetic assemblies forming part of a universal connector apparatus may be configured to rotate with respect to one another in order to align opposite polarities. In some embodiments, the magnetic assemblies rotate with respect to the enclosures. In other embodiments, the magnetic assemblies are fixed within their respective enclosures and the enclosures rotate with respect to one another in order to align the polarities of the encased magnetic assemblies.

In some embodiments, connection members may be secured end to end in order to form a triangle, square, rectangle, another polygon, or another shape. Alternatively, connection members may be joined together at the ends in order to form a polygonal framework having any number of sides, or connection edges. A rotatable multi-pole magnetic assembly may be positioned and rotatably secured adjacent one or more edges of the polygon. For example, a cylindrical magnet may be positioned adjacent each side of a polygon. In still other embodiments, solid objects, such as triangles and squares, may include rotatable multi-pole magnetic assemblies positioned adjacent one or more edges of the polygonal solid object.

An enclosure may be fixedly secured adjacent one or more side edges of a polygonal shape. Accordingly, in order to align polarities, a magnetic assembly within each secured enclosure may be configured to freely rotate in order to align polarities.

In other embodiments, two-dimensional objects, such as squares, rectangles, and triangles, may be magnetically linked in order to create three-dimensional objects, such as pyramids and tetrahedrons.

In some embodiments of methods for forming the multi-pole magnets, a magnetizing apparatus may be adapted to form a multi-pole magnetic assembly, including multiple magnetic sections. A bottom plate may be secured to a top press section via one or more hinges. A cylindrical rod placed within the magnetizing apparatus may then be used to create a multi-pole magnet.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture, a method, or a product of a process.

The components of the embodiments, as generally described and illustrated in the figures herein, could be arranged and designed in a wide variety of different configurations. Some of the infrastructure and manufacturing processes that can be used with embodiments disclosed herein are already available. Accordingly, well-known structures and manufacturing processes associated with magnets, connectors, plastics, forms, metals, composites, and the like, have not been shown or described in detail to avoid unnecessarily obscuring descriptions of the present exemplary embodiments. In addition, the steps of the described methods do not necessarily need to be executed in any specific order, or even sequentially, nor need the steps be executed only once, unless otherwise specified.

The embodiments of the disclosure are best understood by reference to the drawings, wherein like parts are designated by like numerals throughout. In the following description, numerous details are provided to give a thorough understanding of various embodiments. However, the embodiments disclosed herein can be practiced without one or more of the specific details, or with other methods, components, materials, etc. In other instances, well-known structures, materials, or operations are not shown or described in detail to avoid obscuring aspects of this disclosure.

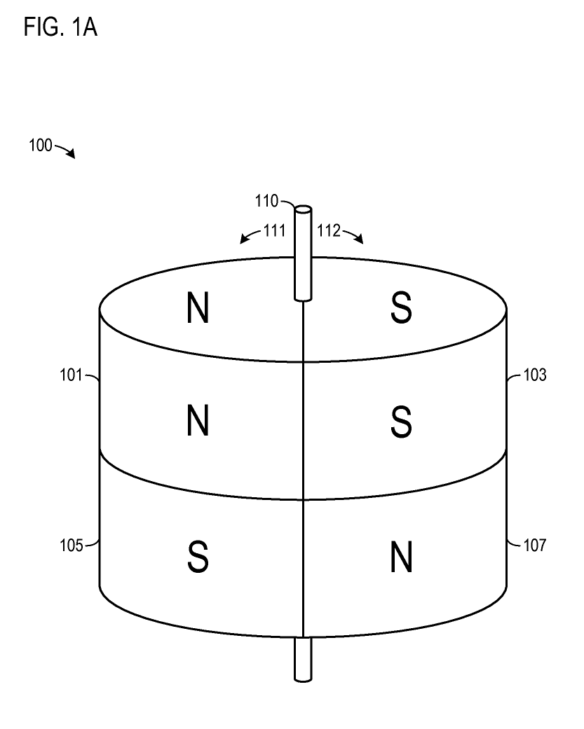

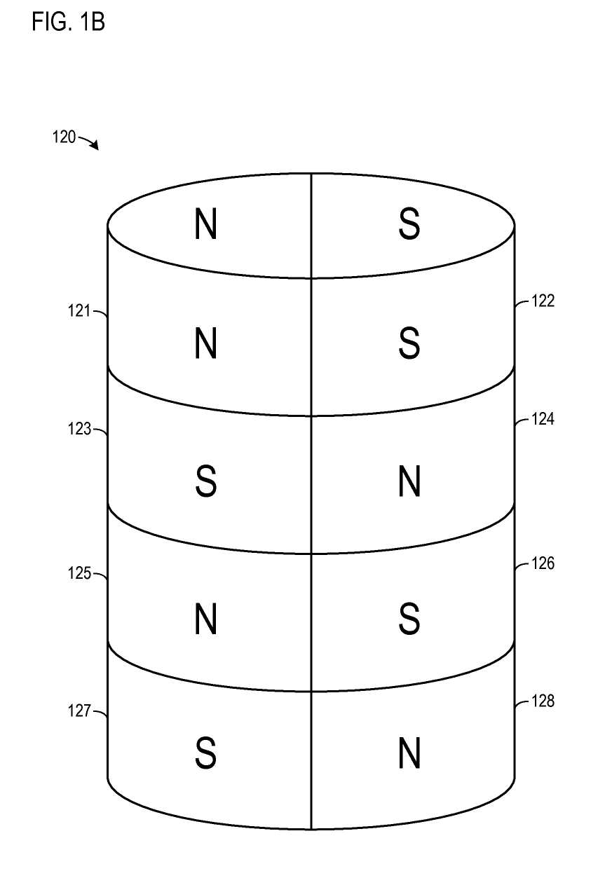

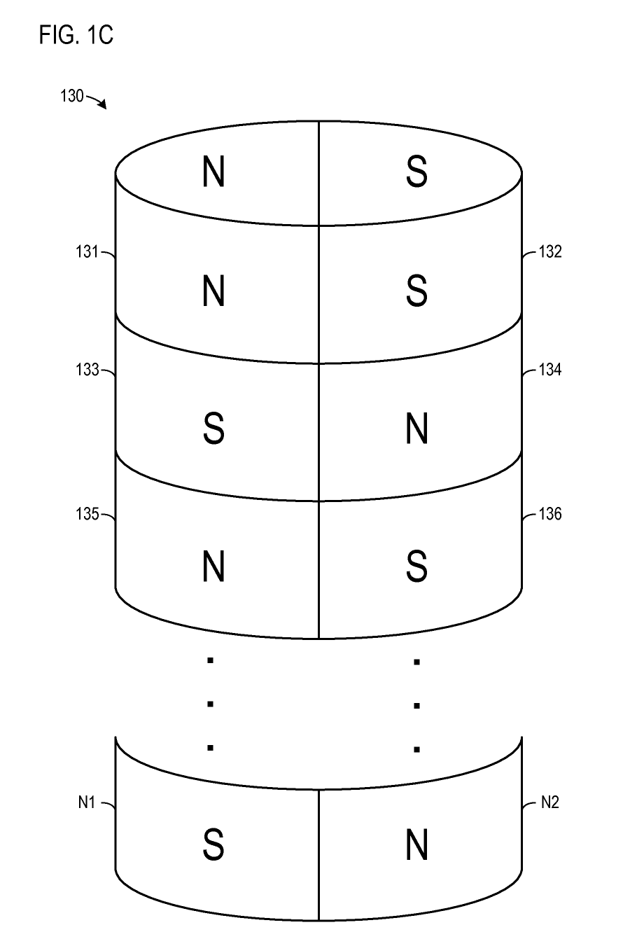

FIG. 1A illustrates a multi-pole magnetic assembly 100 configured with four magnetic sections 101, 103, 105, and 107 of alternating polarities. As illustrated, multi-pole magnetic assembly 100 may include a first half 111 and a second half 112 extending along a longitudinal axis 110. First half 111 may comprise a first magnetic section 101 having a first magnetic polarity (north) and a second magnetic section 105 having an opposite magnetic polarity (south). Second half 112 may include a corresponding number of magnetic sections 103 and 107 having a magnetic polarity opposite that of an adjacent magnetic section 101 and 105, respectively, in first half 111.

FIG. 1B illustrates another embodiment of a multi-pole magnetic assembly 120 similar to that of FIG. 1A. As illustrated, multi-pole magnetic assembly 120 may include eight magnetic sections 121-128, each magnetic section having a magnetic polarity opposite that of each adjacent magnetic section. Again, multi-pole magnetic assembly 120 may include a first half and a second half extending along a longitudinal axis. Each half may include a corresponding number of magnetic sections. As illustrated, a left half may include four magnetic sections 121, 123, 125, and 127 having magnetic polarities north, south, north, south, respectively. A right half may include four corresponding magnetic sections 122, 124, 126, and 128, each having a magnetic polarity opposite that of the adjacent magnetic section in the left half. Accordingly, magnetic sections 122, 124, 126, and 128 may have magnetic polarities south, north, south, north, respectively.

FIG. 1C illustrates a multi-pole magnetic assembly 130 configured with any number of magnetic sections 131-N2, with each magnetic section having a magnetic polarity opposite that of each adjacent magnetic section. As conveyed by FIG. 1C, a multi-pole magnetic assembly 130 may include any number of magnetic sections as desired. According to various embodiments, a magnetic assembly may include an equal number of magnetic sections with a north polarization as a south polarization. Additionally, the magnetic strength of the magnetic sections having a south polarization may be equal to the magnetic strength of the magnetic sections having a north polarization. According to some embodiments, the volume and/or mass of the magnetic sections having a south polarization may be less than or greater than the volume and/or mass of the magnetic sections having a north polarization.

According to some embodiments, the adjacent oppositely polarized magnetic sections may strengthen or otherwise modify the magnetic fields of other magnetic sections. In some embodiments, the assemblies may be configured such that the magnetic field of one or more outer magnetic sections magnify the magnetic field of one or more of the center magnetic sections. For example, magnetic section 134 may have an increased magnetic flux adjacent thereto due to the interaction of magnetic flux from adjacent magnetic sections 132 and 136. This may lead to the inner magnetic sections having greater lifting strength than the outer magnetic sections.

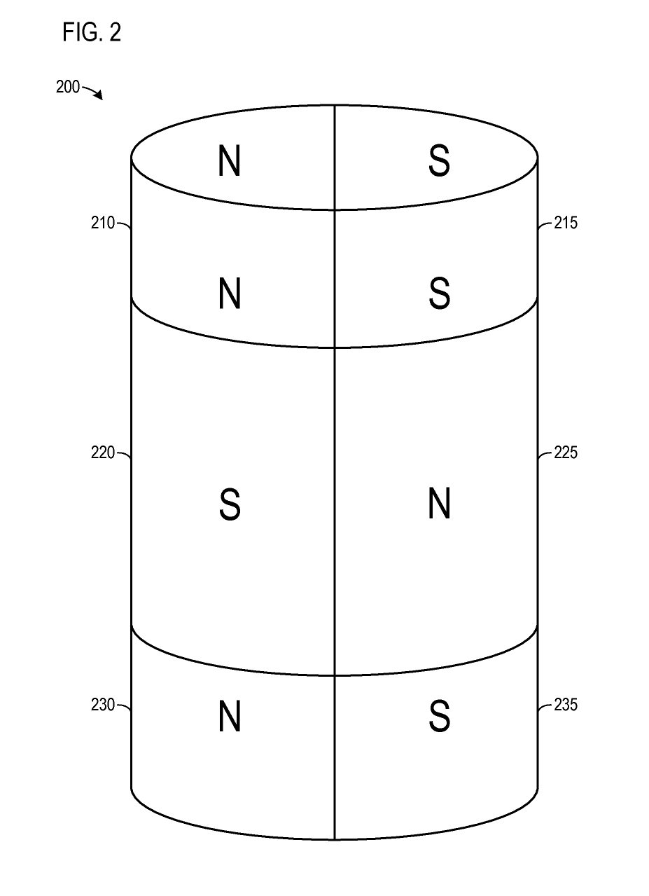

FIG. 2 illustrates a multi-pole magnetic assembly 200 configured with six magnetic sections 210-235, each magnetic section having a magnetic polarity opposite that of each adjacent magnetic section. As illustrated, magnetic sections 220 and 225 may be configured with opposite polarities (south and north, respectively) and may be physically larger magnetic sections than magnetic sections 210, 215, 230, and 235. According to some embodiments, magnetic sections 220 and 225 may have a stronger magnetic strength than magnetic sections 210, 215, 230, and 235. Alternatively, any magnetic section or pair of magnetic sections having opposite polarities may have a stronger magnetic strength than another magnetic section or pair of magnetic sections, independent of physical shape, volume, weight, or dimensions.

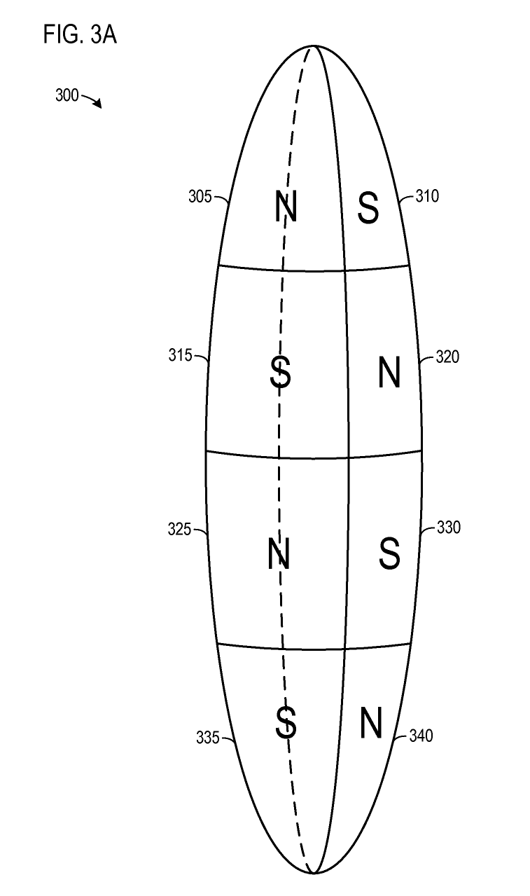

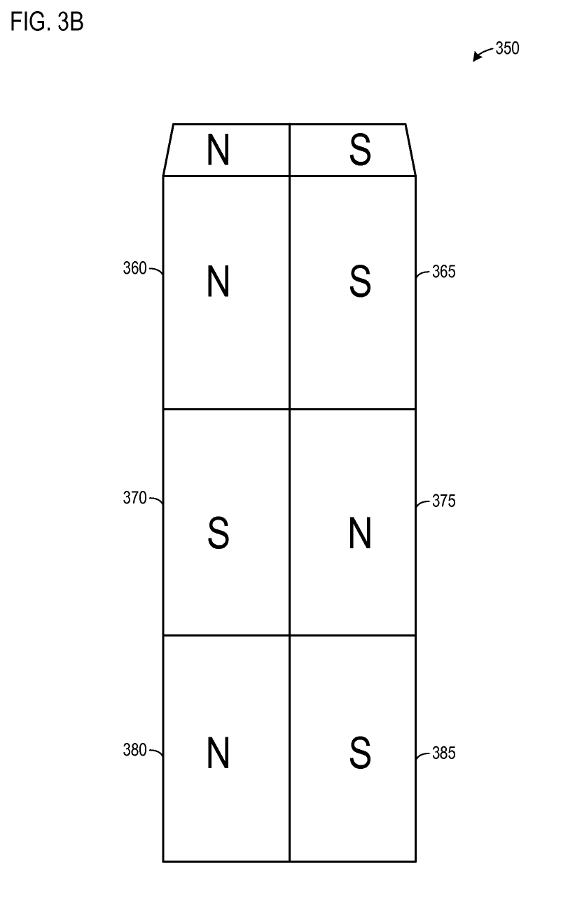

FIGS. 1A-2 illustrate various embodiments of multi-pole magnetic assemblies 100, 120, 130, and 200 having cylindrical configurations. As illustrated in FIGS. 3A and 3B, a multi-pole magnetic assembly may be any shape or size. FIG. 3A illustrates a multi-pole magnetic assembly 300 configured with eight magnetic sections 305-340 each having a magnetic polarity opposite that of each adjacent magnetic section. As illustrated, multi-pole magnetic assembly 300 may be in an oblong, or egg-shaped configuration. The length, width, height, and/or contour of the perimeter of multi-pole magnetic assembly 300 may be adapted or modified as is deemed suitable for a particular application.

Providing another alternative configuration, FIG. 3B illustrates a multi-pole magnetic assembly 350 configured with six magnetic sections 360-385, each having a magnetic polarity opposite that of each adjacent magnetic section. Multi-pole magnetic assembly 350 is a rectangular prism configuration. According to various embodiments, the length, width, and height of magnetic assembly 350 may be adapted for a particular application.

The various embodiments of multi-pole magnetic assemblies described in conjunction with FIGS. 1A-3B are merely illustrative and are not the only contemplated shapes, sizes, or configurations. Additional shapes and sizes of multi-pole magnetic assemblies are contemplated having any of a wide variety of shapes and sizes, including any polygonal regular or irregular prismic, circular cylindrical, and/or elliptical cylindrical shape. Prismic multi-pole magnetic assemblies may include bases at right angles, obtuse angles, and/or acute angles. Moreover, the perimeter may be irregular and/or include a non-flat base, such as the oblong multi-pole magnetic assembly illustrated in FIG. 3A.

A multi-pole magnetic assembly may be formed using any of a wide variety of magnetizable materials. A multi-pole magnetic assembly may be a single continuous magnetic material including a plurality of adjacent magnetic sections each polarized with a magnetic polarity opposite that of each adjacent magnetic section. Alternatively, a multi-pole magnetic assembly may be a single physical material including a plurality of adjacent magnetic sections each polarized with a magnetic polarity opposite that of each adjacent magnetic section, where each pair of oppositely polarized magnetic sections is separated from another pair of oppositely polarized magnetic sections by a non-magnetically polarized section of material. According to yet another embodiment, a multi-pole magnetic assembly may be formed by joining multiple pairs of oppositely polarized magnetic sections. In such an embodiment, a multi-pole magnetic assembly may include a plurality of magnets polarized along their longitudinal axes magnetically linked end to end, such that each magnetic section is magnetically polarized opposite that of each adjacent magnetic section.

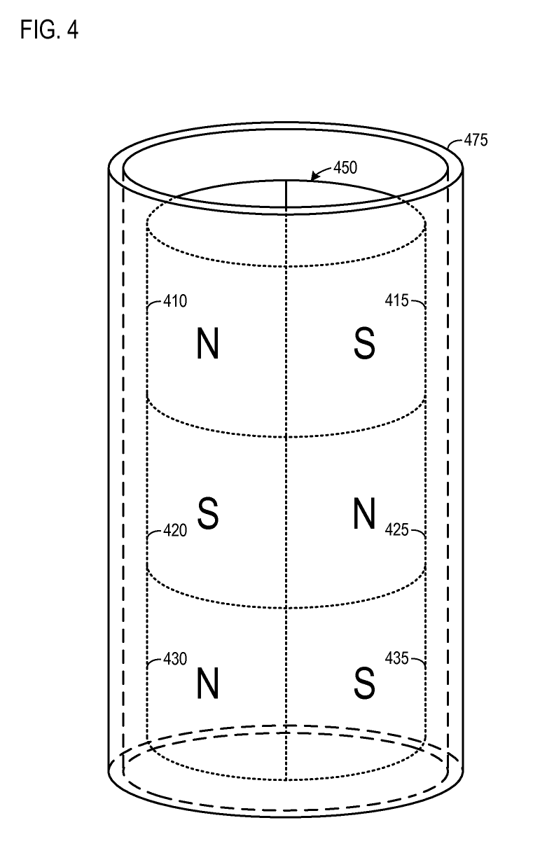

FIG. 4 illustrates a cylindrical multi-pole magnetic assembly 450 encased within a connection member comprising a cylindrical enclosure 475. As illustrated, multi-pole magnetic assembly 450 may include six magnetic sections 410-435, each magnetic section 410-435 having a magnetic polarity opposite that of each adjacent magnetic section. According to various embodiments, cylindrical enclosure 475 may be a circular cylinder, as illustrated, or may be an elliptical cylinder. Multi-pole magnetic assembly 450 may be free to translate within cylindrical enclosure 475 along a longitudinal axis, or may be longitudinally fixed. Additionally, multi-pole magnetic assembly 450 may be free to rotate about its longitudinal axis within cylindrical enclosure 475, or may be fixedly secured within cylindrical enclosure 475.

Other embodiments are contemplated in which an enclosure is not necessary. For example, a rod may be positioned to extend through a central axis of one or more magnetic assemblies to facilitate the rotation. Such a rod may be positioned within a cavity or opening positioned within the magnetic connector apparatus if desired.

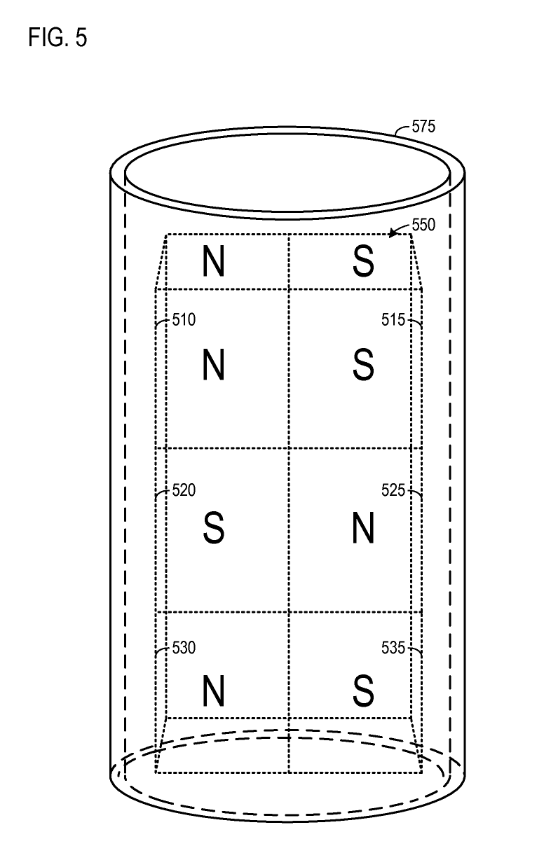

FIG. 5 illustrates a rectangular prismic multi-pole magnetic assembly 550 encased within a connection member comprising a cylindrical enclosure 575. Rectangular prismic multi-pole magnetic assembly 550 may include six magnetic sections 510-535, each magnetic section 510-535 having a magnetic polarity opposite that of each adjacent magnetic section. According to various embodiments, cylindrical enclosure 575 may be a circular cylinder, as illustrated, or may be an elliptical cylinder. Multi-pole magnetic assembly 550 may be free to translate within cylindrical enclosure 575 along a longitudinal axis, or may be longitudinally fixed. Multi-pole magnetic assembly 550 may be free to rotate about its longitudinal axis within cylindrical enclosure 575, or may be fixedly secured within cylindrical enclosure 575.

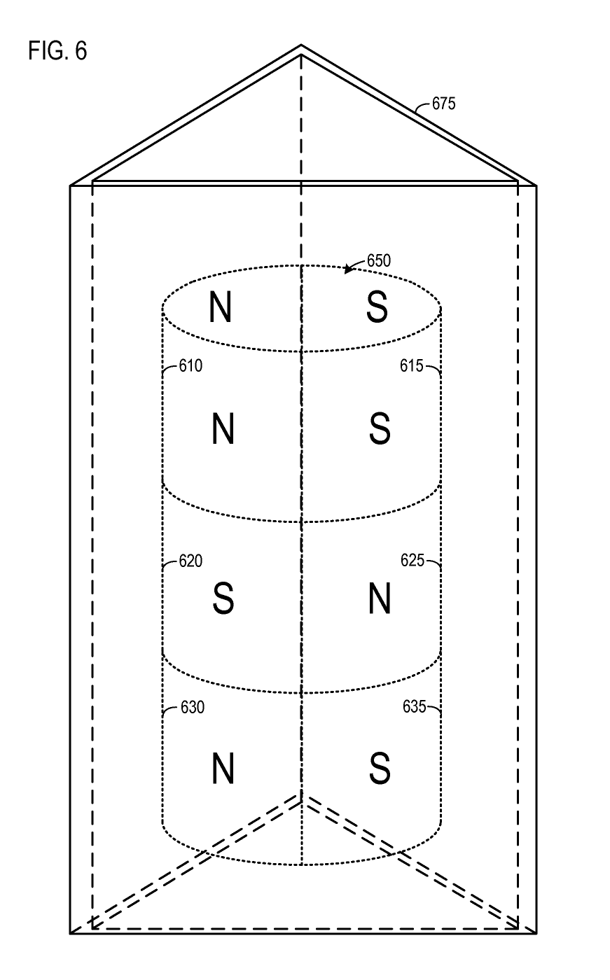

FIG. 6 illustrates a cylindrical multi-pole magnetic assembly 650 encased within a connection member comprising a triangular prismic enclosure 675. Multi-pole magnetic assembly 650 may include six magnetic sections 610-635, each magnetic section 610-635 having a magnetic polarity opposite that of each adjacent magnetic section. According to various embodiments, triangular prismic enclosure 675 may be modified to be any polygonal prismic enclosure having any number of sides, dimensions, heights, and/or base angles. Multi-pole magnetic assembly 650 may be free to translate within prismic enclosure 675 along a longitudinal axis, or may be longitudinally fixed. Multi-pole magnetic assembly 650 may be free to rotate about its longitudinal axis within prismic enclosure 675, or may be fixedly secured within prismic enclosure 675.

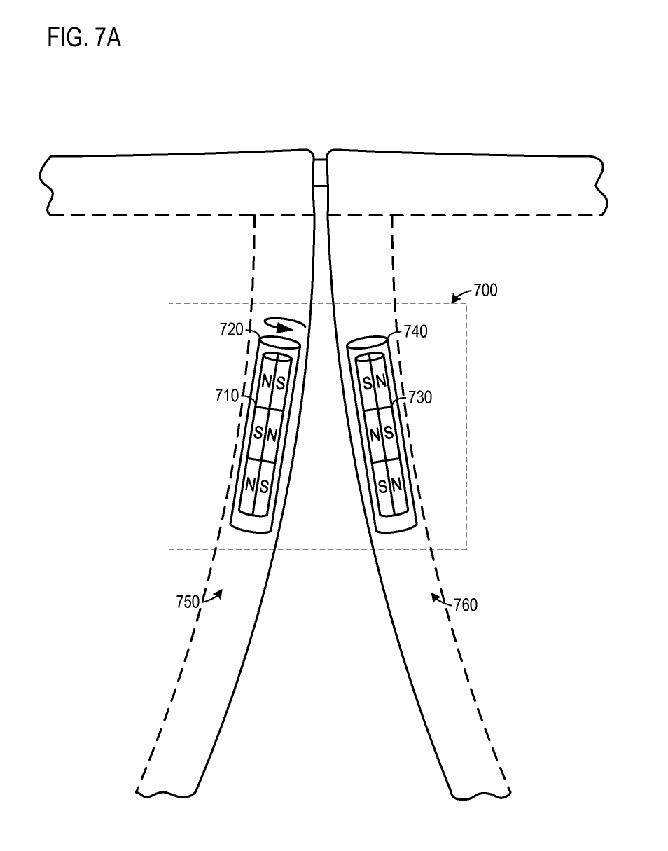

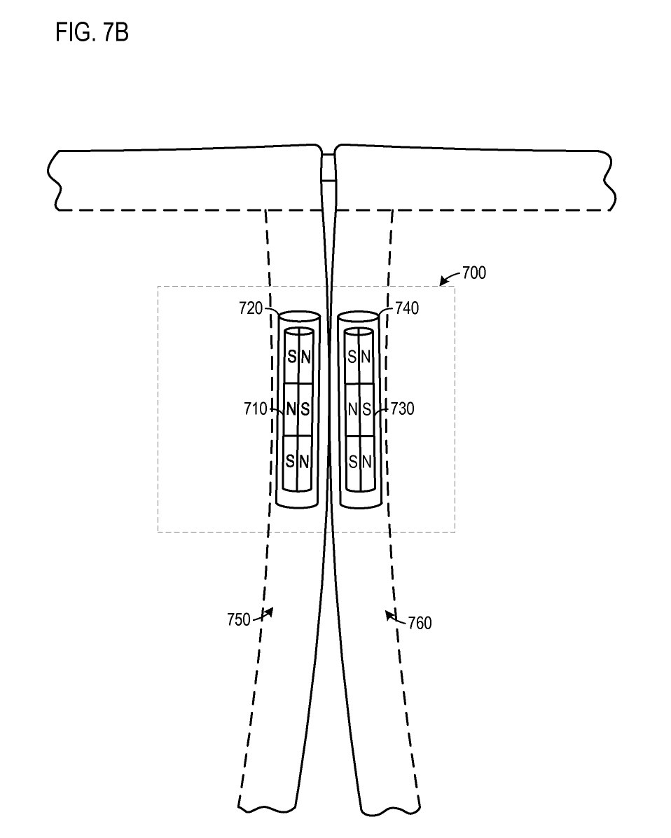

FIG. 7A illustrates a connector apparatus 700 comprising two cylindrical multi-pole magnetic assemblies 710 and 730 configured to rotatably align polarities in order to magnetically link two connection members comprising sections 750 and 760 of a fabric. As illustrated, each multi-pole magnetic assembly 710 and 730 may be encased within an enclosure 720 and 740, respectively. As illustrated, the polarities of the magnetic sections of multi-pole magnetic assembly 710 are not aligned with the magnetic sections of multi-pole magnetic assembly 730. Accordingly, in the orientation illustrated in FIG. 7A, multi-pole magnetic assemblies 710 and 730 would repel one another.

According to various embodiments, the repulsion of the magnetic sections of multi-pole magnetic assemblies 710 and 730 may cause one or both of multi-pole magnetic assemblies 710 and 730 to rotate about a longitudinal axis in order to align the polarities of the magnetic sections of each of multi-pole magnetic assemblies 710 and 730. This rotation may comprise a rotation of the magnetic assemblies within a fixed enclosure or, alternatively, may comprise a rotation of the enclosures themselves, as described in greater detail below. The transition from FIG. 7A to FIG. 7B illustrates multi-pole magnetic assembly 710 rotating about its longitudinal axis in order to magnetically link with multi-pole magnetic assembly 730.

According to some embodiments, multi-pole magnetic assembly 710 may rotate about a longitudinal axis within and with respect to enclosure 720. In such an embodiment, multi-pole magnetic assembly and enclosure combinations 710, 720 and 730, 740 may be fixedly attached to fabric sections 750 and 760. Alternatively, multi-pole magnetic assembly 710 may be fixed within enclosure 720, and enclosure 720 may be configured to rotate about its longitudinal axis in order to align the magnetic sections of each of multi-pole magnetic assemblies 710 and 730. In such an embodiment, Multi-pole magnetic assembly and enclosure combinations 710, 720 and 730, 740 may be rotatably secured within a hem or other cavity of fabric sections 750 and 760.

FIG. 7B illustrates a connector apparatus 700 comprising the two cylindrical multi-pole magnetic assembly and enclosure combinations 710, 720 and 730, 740. As illustrated, with the magnetic sections of each of multi-pole magnetic assemblies 710 and 730 aligned, multi-pole magnetic assembly and enclosure combinations 710, 720 and 730, 740 may magnetically link with one another, and thereby link fabric sections 750 and 760. In addition to linking fabric, such as fabric sections 750 and 760, one or more multi-pole magnetic assembly and enclosure combinations, such as multi-pole magnetic assembly and enclosure combinations 710, 720 and 730, 740, may be used to magnetically link any of a wide variety of materials, components, or products.

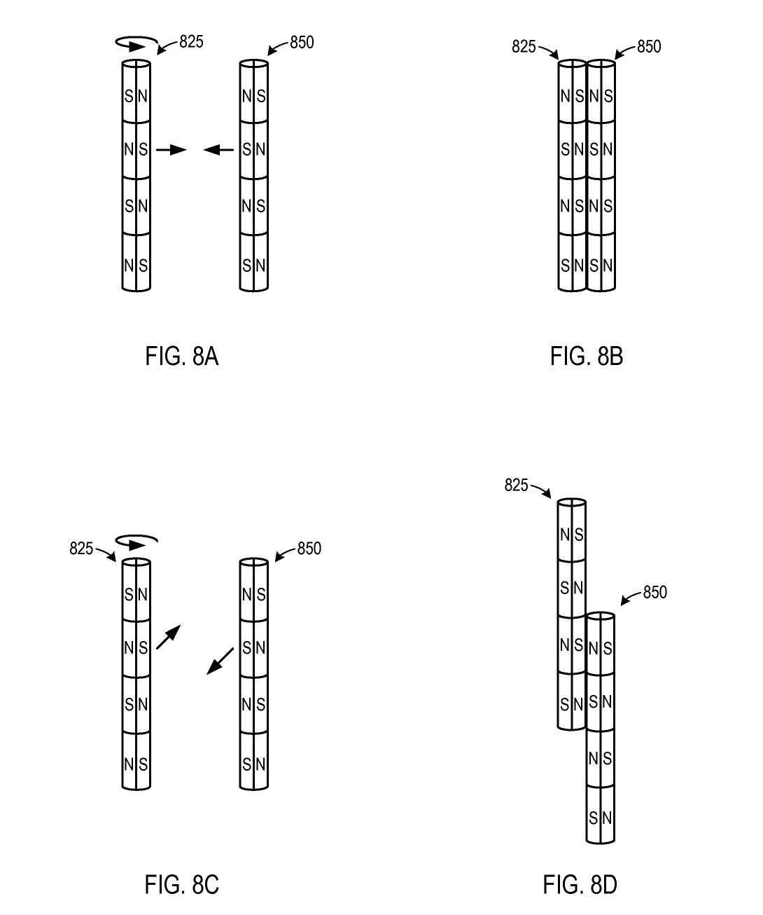

FIG. 8A illustrates a first multi-pole magnetic assembly 825 and a second multi-pole magnetic assembly 850. In this embodiment, each of the first and second multi-pole magnetic assemblies 825 and 850 include eight magnetic sections. Each magnetic section may have a magnetic polarity opposite that of each adjacent magnetic section. As second multi-pole magnetic assembly 850 approaches first multi-pole magnetic assembly 825, first multi-pole magnetic assembly 825 may rotate to align the polarities of the respective magnetic sections of first and second multi-pole magnetic assemblies 825 and 850 so that they may magnetically link.

As illustrated in FIG. 8B, the rotation of first multi-pole magnetic assembly 825 about its longitudinal axis may align the polarities of its magnetic sections with those of the second multi-pole magnetic assembly, as illustrated in FIG. 8B. Once the polarities are properly aligned, first and second multi-pole magnetic assemblies 825 and 850 may magnetically link along aligned outside perimeters. In an alternative embodiment, second multi-pole magnetic assembly 850 may rotate in addition to, or instead of, first multi-pole magnetic assembly 825.

FIGS. 8C-8D illustrate first multi-pole magnetic assembly 825 rotating about its longitudinal axis in order to magnetically link with second multi-pole magnetic assembly 850 along askew outer perimeters. As illustrated in FIG. 8C, first multi-pole magnetic assembly 825 may rotate about its longitudinal axis in order to properly align the respective magnetic sections of first and second multi-pole magnetic assemblies 825 and 850.

One result of using multi-pole magnetic assemblies, as opposed to bi-pole magnets, is that two or more multi-pole magnetic assemblies may be magnetically linked along outer perimeters that are longitudinally askew with respect to one another. As illustrated in FIG. 8D, first multi-pole magnetic assembly 825 may be magnetically linked to second multi-pole magnetic assembly 850 longitudinally askew by two magnetic sections. In other embodiments, first multi-pole magnetic assembly 825 may include any number of magnetic sections, and second multi-pole magnetic assembly 850 may be magnetically linked along longitudinally askew outer perimeters by one or more magnetic sections.

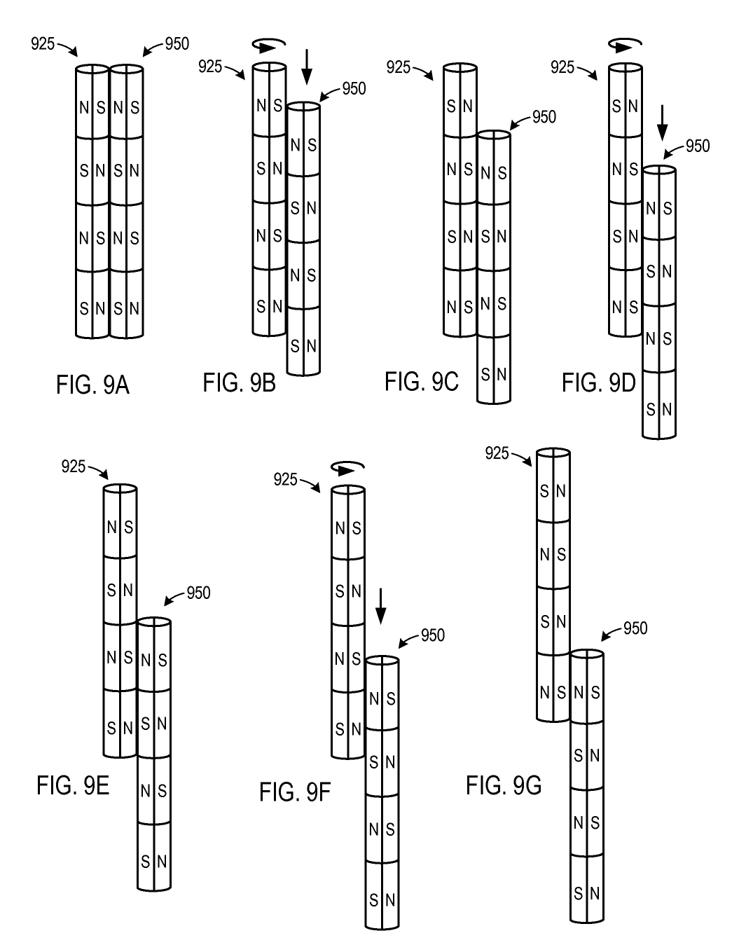

FIGS. 9A-9G illustrate a first multi-pole magnetic assembly 925 and a second multi-pole magnetic assembly 950 rotatably interacting and maintaining a magnetic link while second multi-pole magnetic assembly 950 is translated along a longitudinal axis with respect to first multi-pole magnetic assembly 925. Beginning with FIG. 9A, first multi-pole magnetic assembly 925 may be magnetically linked with second multi-pole magnetic assembly 950 along aligned outer perimeters. Though illustrated as cylindrical herein, first and second multi-pole magnetic assemblies 925 and 950 may be cylindrical, spherical, oblong, rectangular, parallelepiped, trapezoidal, and/or any other suitable shape. Moreover, first and second multi-pole magnetic assemblies 925 and 950 may each include a first half and a second half extending along a longitudinal axis, each half including any number of magnetic sections having magnetic polarities opposite that of each adjacent magnetic section. As illustrated in FIGS. 9A-9G, each multi-pole magnetic assembly 925 and 950 includes eight magnetic sections of alternating polarities.

In FIG. 9B, second multi-pole magnetic assembly 950 is longitudinally translated along an outer perimeter of first multi-pole magnetic assembly 925. As the polarities of the respective magnetic sections become misaligned, first multi-pole magnetic assembly 925 may rotate in order to maintain the proper polarity alignment. Once first multi-pole magnetic assembly 925 has rotated, second multi-pole magnetic assembly 950 may be magnetically linked longitudinally askew by one magnetic section, as illustrated in FIG. 9C. Alternatively, second multi-pole magnetic assembly 950 may rotate to maintain the proper polarity alignment.

Continuing with FIG. 9D, second multi-pole magnetic assembly 950 may be further longitudinally translated with respect to first multi-pole magnetic assembly 925. Again, as the polarities of the respective magnetic sections become misaligned, first multi-pole magnetic assembly 925 may rotate in order to maintain the proper polarity alignment for first and second multi-pole magnetic assemblies 925 and 950 to remain magnetically linked. As illustrated in FIG. 9E, first and second multi-pole magnetic assemblies 925 and 950 remain magnetically linked longitudinally askew by two magnetic sections.

FIG. 9F illustrates second multi-pole magnetic assembly 950 as it is further translated with respect to first multi-pole magnetic assembly 925. First multi-pole magnetic assembly 925 may rotate again in order to maintain an attractive polarity alignment between the respective magnetic sections of first and second multi-pole magnetic assemblies 925 and 950. As illustrated in FIG. 9G, first and second multi-pole magnetic assemblies 925 and 950 may remain magnetically linked along askew outer perimeters, such that a single magnetic section from each multi-pole magnetic assembly 925 and 950 maintains the magnetic link.

It should be understood from the discussion accompanying FIGS. 8A-8D and 9A-9F that various embodiments of the multi-pole magnetic assemblies disclosed herein may have a plurality of individual connection points with respect to an adjacent multi-pole magnetic assembly. Typically, each such assembly will have as many connection points as there are pairs of magnetic sections.

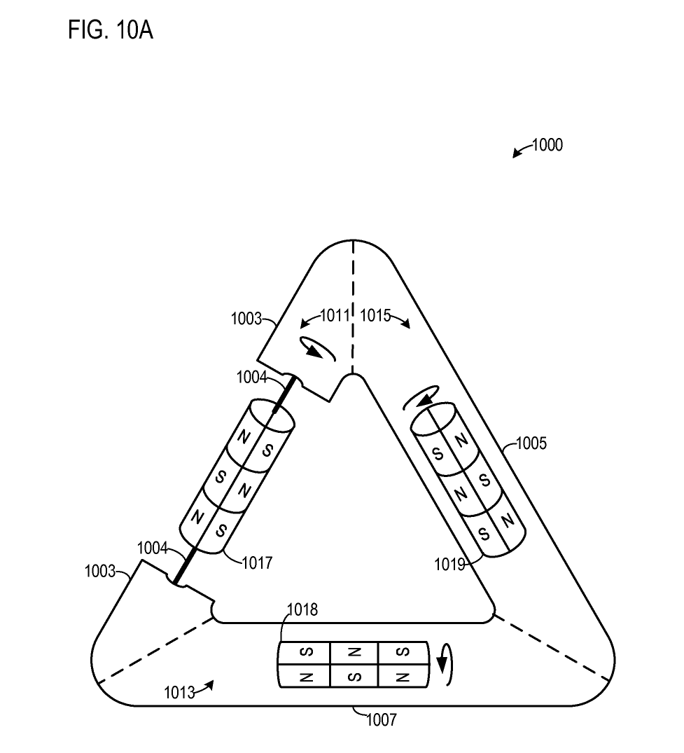

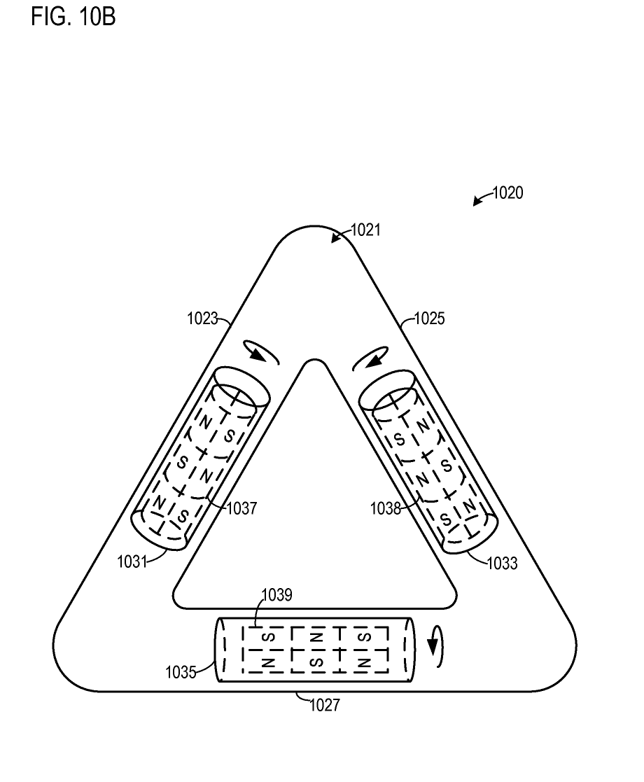

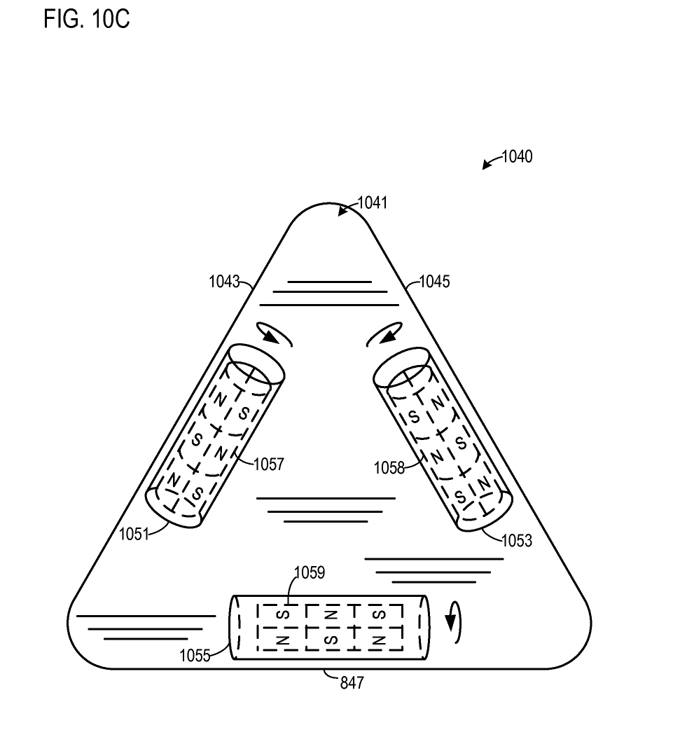

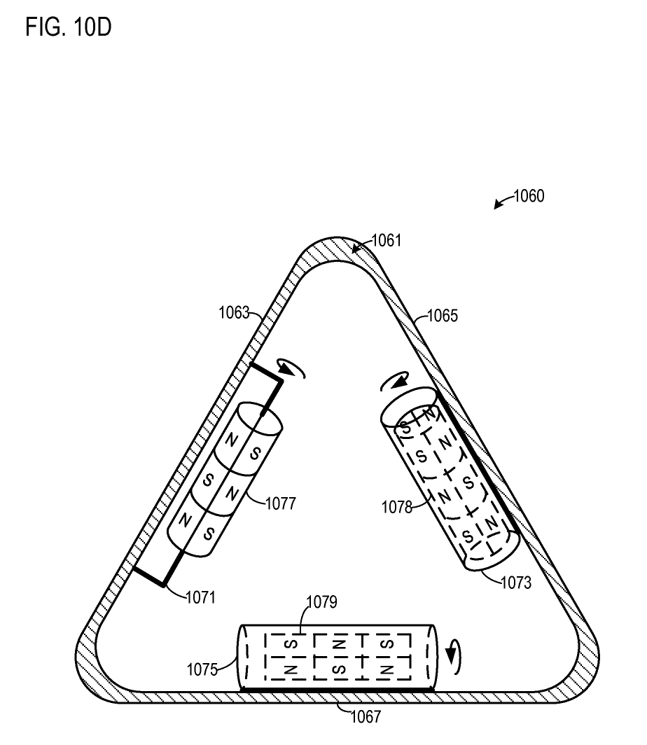

FIG. 10A illustrates a connection apparatus comprising a connection member 1000. Connection member 1000 comprises three connection edges 1003, 1005, and 1007. Connection edge 1003 comprises an open region comprising a connection rod 1004. Connection rod 1004 extends through a central axis of multi-pole magnetic assembly 1017 and allows multi-pole magnetic assembly 1017 to rotate around the connection rod 1004. In some embodiments, rod 1004 may comprise an upper rod section and a lower rod section, and may be connected to a central axis of multi-pole magnetic assembly 1017, but not extend all of the way therethrough. Additionally, instead of an open region, connection rod 1004 may be positioned within a cavity formed within a connection member.

Connection member 1000 also comprises two other connection edges 1005 and 1007, each of which encloses a multi-pole magnetic assembly 1018 and 1019 in an enclosure 1013 and 1015, respectively. Each of the connection edges together make up a triangular configuration. As illustrated in FIG. 10A, each multi-pole magnetic assembly 1017, 1018, and 1019 may be configured to rotate about its longitudinal axis. Thus, each connection edge 1003, 1005 and 1007 of triangle 1000 may include a multi-pole magnetic assembly 1017, 1018, and 1019 adapted to rotate about its longitudinal axis. The multi-pole magnetic assembly 1017, 1018, and 1019 may rotate adjacent the connection edge 1003, 1005 and 1007 of triangle 1000 and align the polarities of each of its magnetic sections with those of another multi-pole magnetic assembly. Accordingly, triangle 1000 may be magnetically linked at any angle with another triangle with a similar configuration as triangle 1000, or another magnetic connector apparatus of another configuration, along any of sides 1003, 1005 and 1007.

FIG. 10B illustrates a connection member 1020 comprising three connection edges or sides 1023, 1025 and 1027 in a triangular configuration, including a magnetic assembly and enclosure combination 1037, 1031 and 1038, 1033 and 1039, 1035 adjacent each connection edge. According to various embodiments, multi-pole magnetic assemblies 1037, 1038, and 1039 may be cylindrical, prismic, and/or another shape. Enclosures 1031, 1033, and 1035 may be cylindrical, prismic and/or another shape. For example, magnetic assemblies 1037, 1038, and 1039 may be configured as spherical magnetic assemblies having two or more magnetic sections. In such an embodiment, enclosures 1031, 1033, and 1035 may be configured as corresponding spheres or cylinders adapted to encase the spherical magnetic assemblies.

Magnetic assemblies 1037, 1038, and 1039 may be configured to rotate within and with respect to enclosures 1031, 1033, and 1035. Alternatively, magnetic assemblies 1037, 1038, and 1039 may be fixed within enclosures 1031, 1033, and 1035. In such an embodiment, magnetic assemblies 1037, 1038, and 1039 may be configured to rotate about their longitudinal axes. In either embodiment, enclosures 1031, 1033, and 1035 may rotate about their longitudinal axes to align the polarities of each magnetic section of each magnetic assembly 1037, 1038, and 1039 with another magnetic assembly in order to magnetically link a side 1023, 1025 and 1027 with another object containing a similar magnetic assembly, such as another triangle similar to triangular connection member 1020.

FIG. 10C illustrates a connection member 1040 comprising three connection edges in a triangular configuration, including a magnetic assembly and enclosure combination 1057, 1051 and 1058, 1053 and 1059, 1055 adjacent each connection edge 1043, 1045, and 1047. Similar to previously described embodiments, magnetic assemblies 1057, 1058, and 1059 may be configured to rotate within and with respect to enclosures 1051, 1053, and 1055. Alternatively, magnetic assemblies 1057, 1058, and 1059 may be fixed within enclosures 1051, 1053, and 1055. In such an embodiment, enclosures 1051, 1053, and 1055 may be configured to rotate about their longitudinal axes. In still another embodiment, enclosures 1051, 1053, and 1055 may be omitted and magnetic assemblies 1057, 1058, and 1059 may be configured to rotate about their longitudinal axes within cavities or hollows adjacent sides 1043, 1045, and 1047 of triangular connection member 1040.

FIG. 10D illustrates a connection member 1060 comprising three connection edges 1063, 1065, and 1067 in a triangular framework. A magnetic assembly and enclosure combination 1078, 1073 and 1079, 1075 may be fixedly attached to each of connection edges 1065 and 1067. According to the illustrated embodiment, enclosures 1073 and 1075 may be fixedly attached to an inner or outer portion of each side section 1065 and 1067. Magnetic assemblies 1078 and 1079 may be configured to rotate within and with respect to enclosures 1073 and 1075, so as to align the polarities of each magnetic section of each magnetic assembly 1078 and 1079 in order to magnetically link respective connection edges 1065 and 1067 with another object containing a similar magnetic assembly, such as another triangle similar to triangular connection member 1060. Alternatively, a magnetic connector apparatus of another configuration, such as one having only a single edge or connection member, may be connected with the magnetic connector apparatus configured as triangular framework 1060, or any of the other magnetic connector apparatus disclosed herein. As shown in the figure, connection edge 1063 comprises a connection rod 1071 that is attached to, and substantially parallel to, but offset from, connection edge 1063. Multi-pole magnetic assembly 1077 may be configured to rotate about connection rod 1071 in order to magnetically link connection edge 1063 with a connection edge of another object.

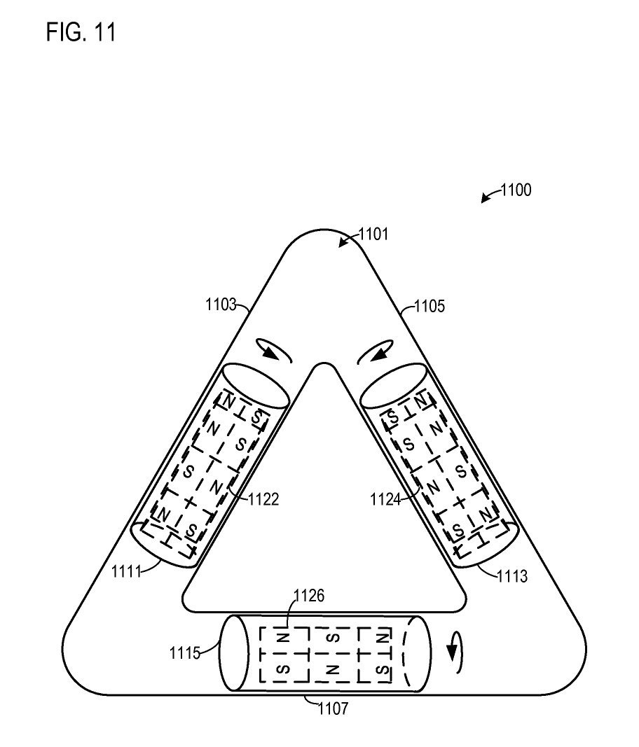

FIG. 11 illustrates a connection member 1100 comprising three connection edges or sides 1103, 1105, and 1107 in a triangular configuration, each connection edge 1103, 1105, and 1107 including a cylindrical enclosure 1111, 1113, and 1115 encasing a rectangular prismic multi-pole magnetic assembly 1122, 1124, and 1126. According to various embodiments, rectangular prismic multi-pole magnetic assemblies 1122, 1124, and 1126 may not easily rotate within enclosures 1111, 1113, and 1115 or may be fixedly attached within enclosures 1111, 1113, and 1115. Accordingly, enclosures 1111, 1113, and 1115 may be configured to rotate within each side 1103, 1105, and 1107, so as to allow the polarities of each magnetic section of each multi-pole magnetic assembly 1122, 1124, and 1126 to align with the magnetic sections of other multi-pole magnetic assemblies.

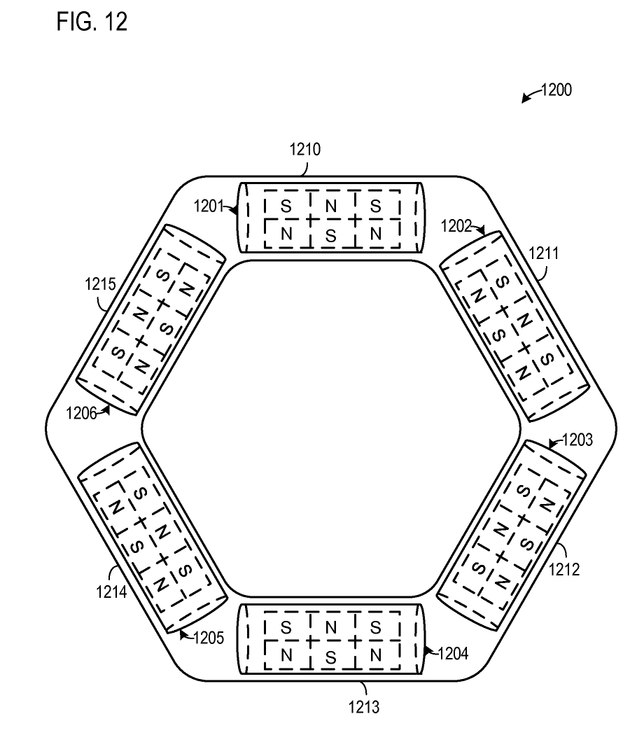

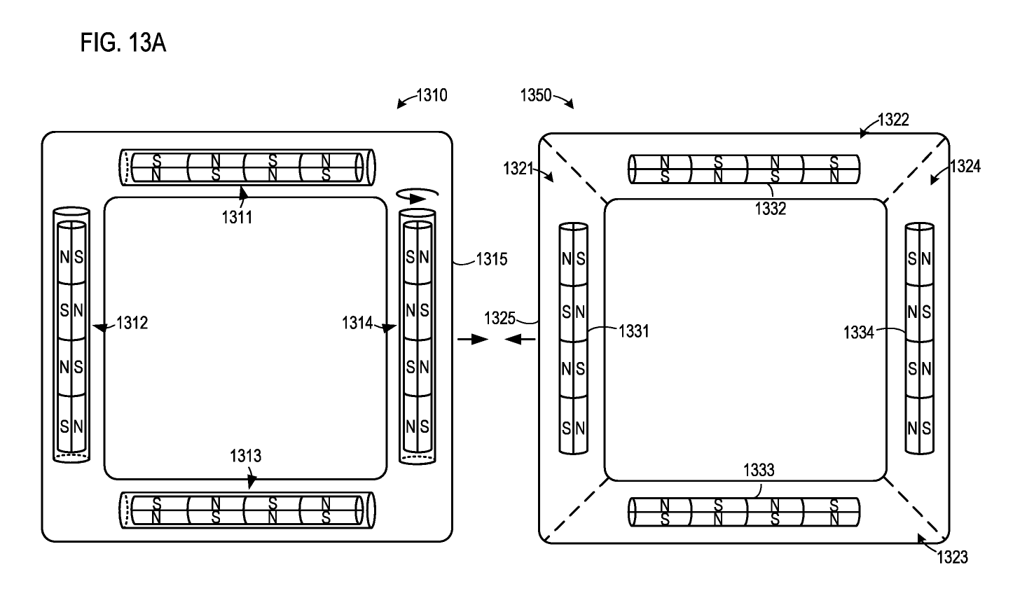

FIG. 12 illustrates a connection member comprising six connection edges 1210-1215 in a hexagonal configuration 1200, including a magnetic assembly and enclosure combination 1201-1206 adjacent each connection edge 1210-1215. As previously described, the multi-pole magnetic assembly within each magnetic assembly and enclosure combination 1201-1206 may be configured to rotate with or, alternatively, with respect to its corresponding enclosure.

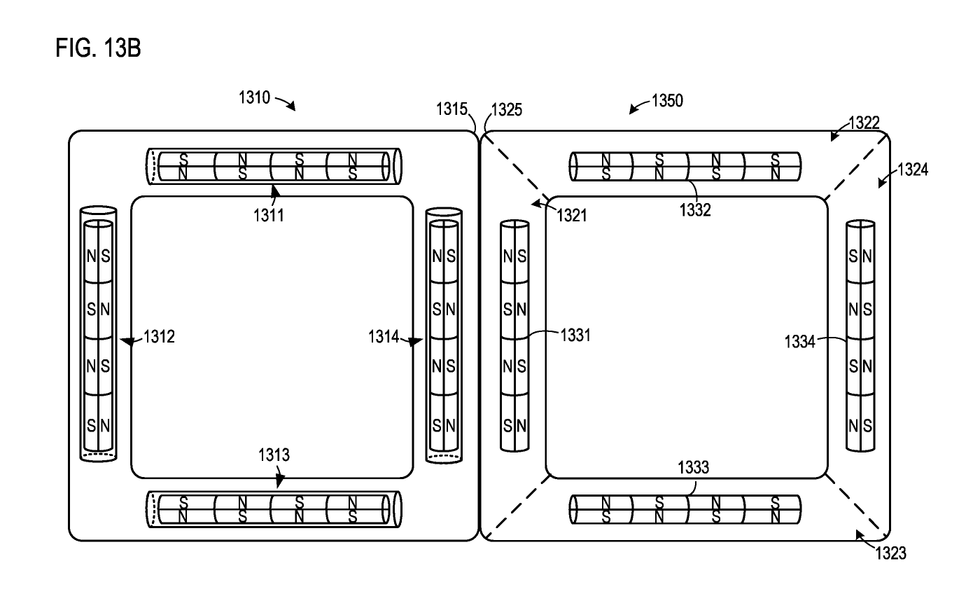

FIG. 13A illustrates a first connector apparatus 1310 comprising a first connection member having four connection edges arranged in a rectangular configuration, and a second connector apparatus 1350 comprising a second connection member having four connection edges 1321-1324. As illustrated, each of the four connection edges, or sides, of first connector apparatus 1310 may encase a magnetic assembly and enclosure combination 1311-1314. According to various embodiments, the multi-pole magnetic assemblies encased within each magnetic assembly and enclosure combination 1311-1314 may be may be cylindrical, prismic, and/or another suitable shape. Similarly, the enclosures themselves may be cylindrical, prismic and/or another shape.

Second connector apparatus 1350 may comprise four enclosures 1321-1324, each encasing a multi-pole magnetic assembly 1331-1334. Enclosures 1321-1324 may be shaped such that they can be connected end to end and form any number of polygonal shapes. Each multi-pole magnetic assembly 1331-1334 may rotate within its respective enclosure 1321-1324 about a longitudinal axis.

As illustrated in FIG. 13A, as first and second connector apparatus 1310 and 1350 approach one another, the multi-pole magnetic assembly within magnetic assembly and enclosure combination 1314 may rotate to align the respective magnetic sections of magnetic assembly and enclosure combination 1314 and multi-pole magnetic assembly 1331. Once the magnetic sections are aligned, first and second connector apparatus 1310 and 1350 may be magnetically linked along longitudinally aligned outer perimeters 1315 and 1325, as illustrated in FIG. 13B. Alternatively, either the multi-pole magnetic assembly 1331 alone, or the enclosure in magnetic assembly and enclosure combination 1314, may rotate about a longitudinal axis in order to align the respective magnetic sections.

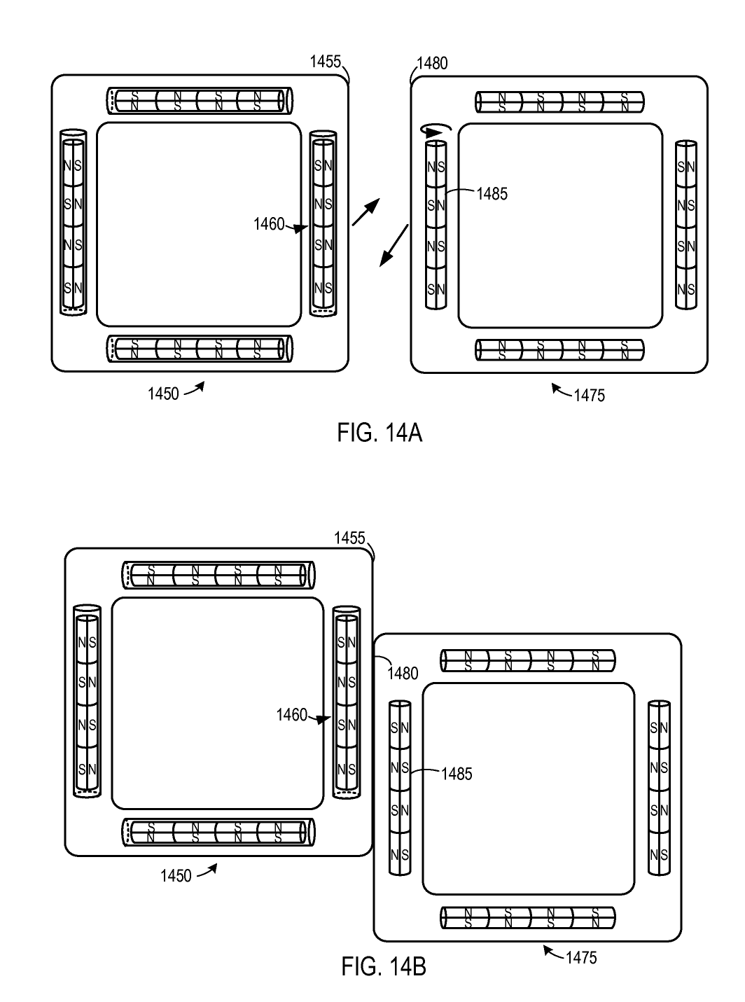

FIG. 14A illustrates a multi-pole magnetic assembly 1485 rotating within a second connector apparatus 1475 in order to magnetically link with a first connector apparatus 1450 along longitudinally askew outer perimeters 1455 and 1480. According to various embodiments, multi-pole magnetic assembly 1485 may rotate in order to align the respective magnetic sections of multi-pole magnetic assembly 1485 and the multi-pole magnetic assembly within magnetic assembly and enclosure combination 1460. According to alternative embodiments, either the multi-pole magnetic assembly within the enclosure of magnetic assembly and enclosure combination 1460 or the enclosure of combination 1460 may rotate along a longitudinal axis instead of multi-pole magnetic assembly 1485.

As illustrated in FIG. 14B, since each multi-pole magnetic assembly within each of first and second connector apparatus 1450 and 1475 includes multiple pairs of magnetic sections (as opposed to just one pair), first and second connector apparatus 1450 and 1475 may magnetically link along longitudinally askew outer perimeters 1455 and 1480, which, as discussed above, results in four separate connection points along each of the sides of the two connector apparatus.

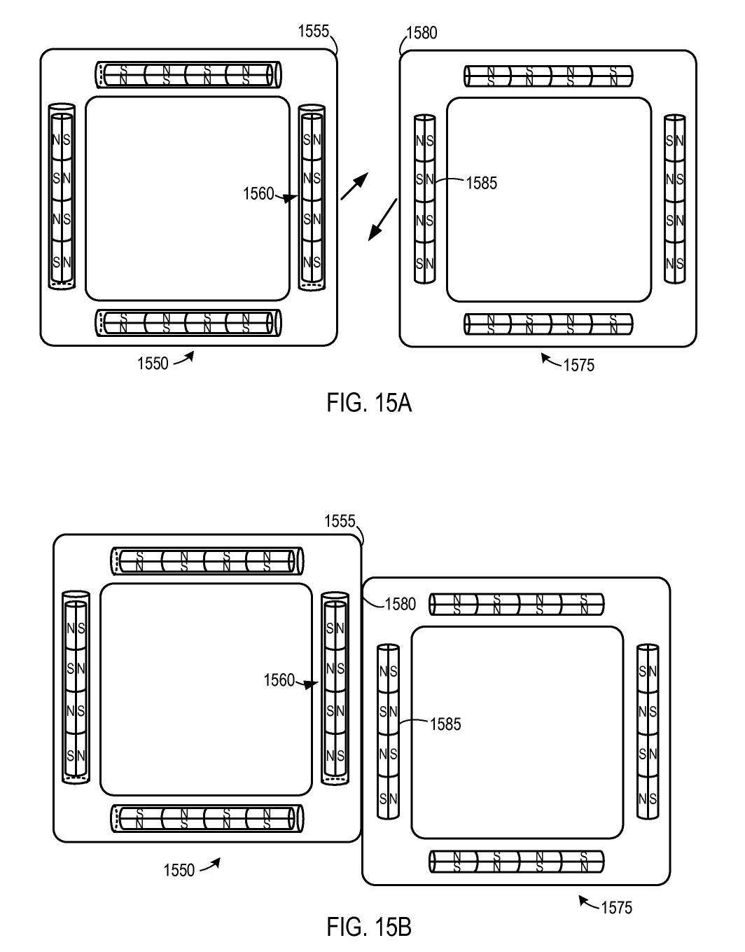

FIG. 15A illustrates first and second connector apparatus 1550 and 1575 approaching one another. As illustrated, the magnetic sections within magnetic assembly and enclosure combination 1560 are not aligned with respect to those of multi-pole magnetic assembly 1585. Accordingly, if first and second connector apparatus 1550 and 1575 were magnetically linked longitudinally aligned along outer perimeters 1555 and 1580, one of the multi-pole magnetic assemblies would need to rotate. However, as illustrated in FIG. 15B, first connector apparatus 1550 may magnetically link with second connector apparatus 1575 such that their respective outer perimeters 1555 and 1580 are longitudinally askew by a single magnetic section without any need for magnetic rotation.

It should also be understood that embodiments are contemplated in which only one of the two connector apparatus that are to be connected together includes a rotatable multi-pole magnetic assembly. As long as one of the multi-pole magnetic assemblies can rotate, it can be connected with another apparatus comprising a multi-pole assembly that is fixed and not rotatable.

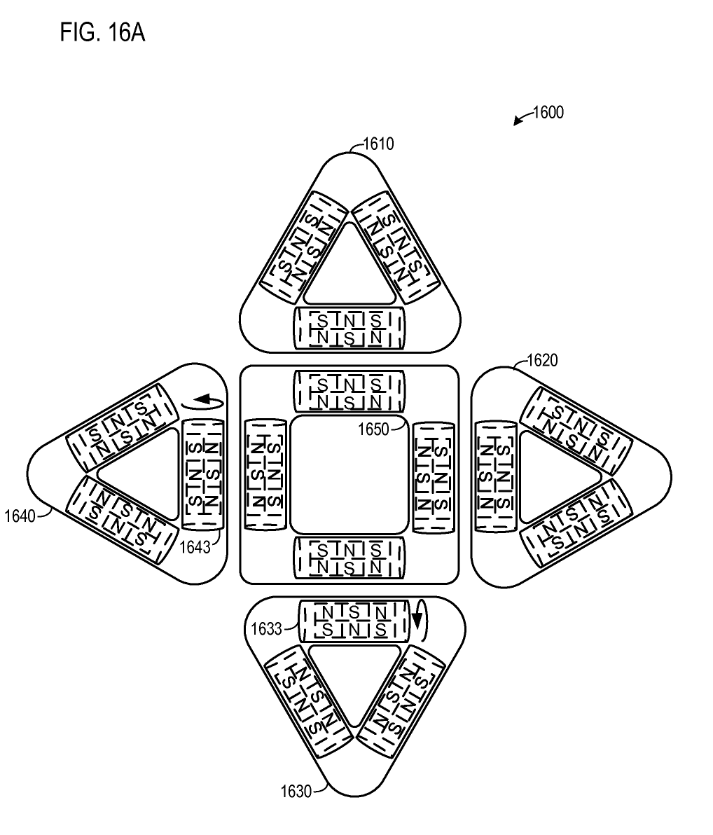

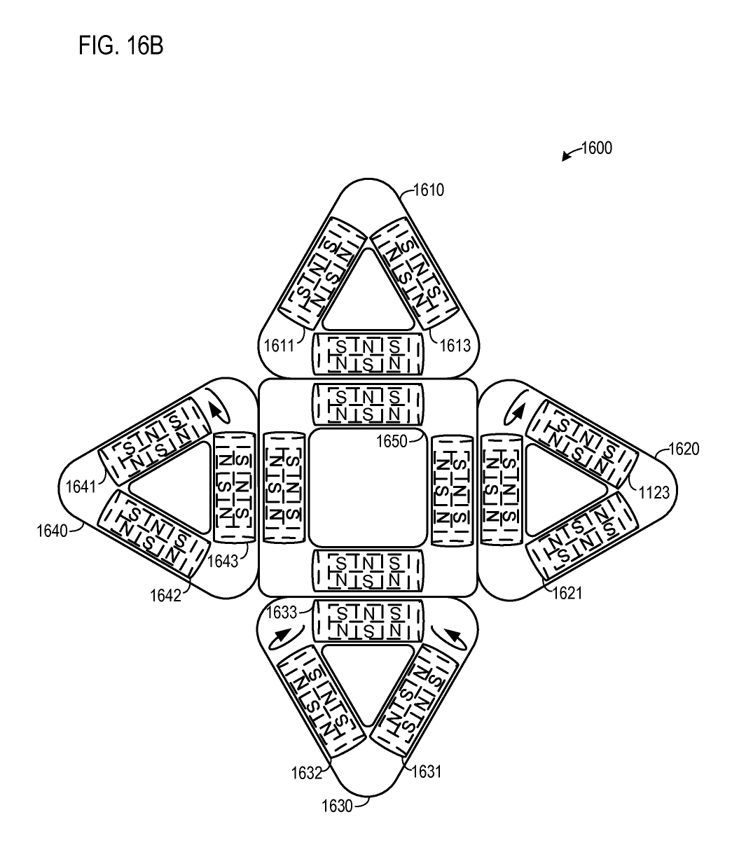

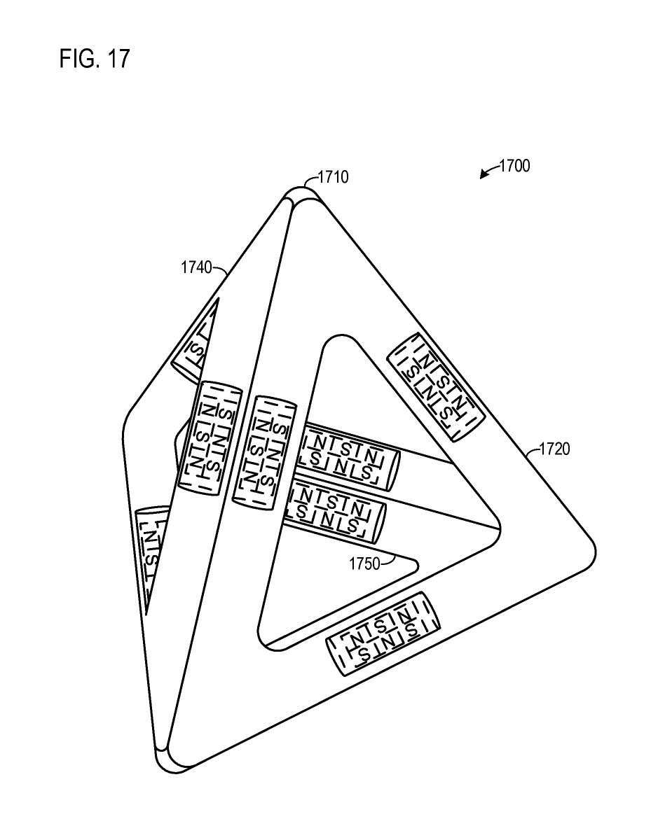

FIG. 16A illustrates a connector apparatus 1600 comprising a rectangular connection member 1650 in the process of being magnetically linked to four triangular connection members 1610-1640. Rectangular connection member 1650 and each of triangular connection members 1610-1640 may include a magnetic assembly or magnetic assembly and enclosure combination adjacent each connection edge of each respective connection member 1610-1650. Each magnetic assembly or magnetic assembly and enclosure combination may be configured to rotate, so as to allow the polarities of each magnetic section of each multi-pole magnetic assembly to align with the magnetic sections of a multi-pole magnetic assembly in an adjacent connection member 1610-1650. Accordingly, each connection edge of rectangular connection member 1650 may be magnetically linked to a connection edge of one of the triangular connection members 1610-1640.

According to various embodiments, the magnetic assembly within each magnetic assembly and enclosure combination may be configured to rotate with or, alternatively, with respect to, its corresponding enclosure. Accordingly, since the magnetic assemblies are free to rotate, the connection edges of each of rectangular connection member 1650 and triangular connection members 1610-1640 may be magnetically linked at any angle, and may be pivoted with respect to one another once linked.

As illustrated in the transition from FIG. 16A to FIG. 16B, multi-pole magnetic assemblies 1633 and 1643 may rotate about their longitudinal axes in order to align the polarities of their respective magnetic sections in order to magnetically link with their respective adjacent multi-pole magnetic assemblies within rectangular connection member 1650.

FIG. 16B illustrates a connector apparatus 1600 comprising rectangular connection member 1650 magnetically linked at each connection edge to a connection edge of each of triangular connection members 1610-1640. Multi-pole magnetic assemblies 1633 and 1643 have rotated about their longitudinal axes in order to align and magnetically link with corresponding multi-pole magnetic assemblies in rectangular connection member 1650.

According to various embodiments, each of triangular connection members 1610-1640 may be pivoted with respect to rectangular connection member 1650 about their respective magnetically linked sides. Accordingly, triangular connection members 1610-1640 may be brought together in order to form a pyramid having a rectangular base and four triangular faces. In such embodiments, each remaining unlinked connection member of each of triangular connection members 1610-1640 may be magnetically linked to a connection edge of another of triangular connection members 1610-1640. The multi-pole magnetic assemblies in each connection edge of each of triangular connection member 1610-1640 may rotate about its longitudinal axis, either with or with respect to an enclosure, in order to align the polarities of the respective magnetic sections.

FIG. 17 illustrates a connector apparatus 1700 comprising four triangular connection members 1710, 1720, 1730, and 1740. Each triangular connection members 1710, 1720, 1730, and 1740 may include one or more multi-pole magnetic assembly and enclosure combinations. Each multi-pole magnetic assembly and enclosure combination may rotatably allow each connection edge of each of triangular connection members 1710, 1720, 1730, and 1740 to magnetically link with another connection edge of another of triangular connection members 1710, 1720, 1730, and 1740, so as to form a tetrahedron. According to various embodiments, each connection edge of each triangular connection member 1710, 1720, 1730, and 1740 may comprise an enclosure and encase a multi-pole magnetic assembly configured to rotate about its longitudinal axis.

Alternatively, each connection edge of each triangular connection member 1710, 1720, 1730, and 1740 may secure, either rotatably or fixedly, an enclosure configured to encase one or more multi-pole magnetic assemblies. In embodiments in which the connection member fixedly secures an enclosure, the multi-pole magnetic assembly may be configured to rotate about its longitudinal axis within and with respect to the enclosure. In embodiments in which the connection member rotatably secures an enclosure, the multi-pole magnetic assembly may be configured to rotate about its longitudinal axis together with the enclosure as the enclosure rotates.

According to various embodiments, any polygonal shape may be used in place of triangular connection members 1710, 1720, 1730, and 1740 and magnetically link in order to form a polyhedron having any number of faces. Similarly, any combination of various polygonal shapes may be magnetically linked in order to form any number of shapes and/or compositions of shapes. For example, four rectangular connection members may be linked together with four triangular connection members in order to form an obelisk. Moreover, some embodiments may comprise members extending generally in only a single dimension, such that polygonal shapes may be made using several separate magnetic connector apparatus, each making up one side of the polygon.

As previously described, a multi-pole magnetic assembly may be formed using a single continuous magnetic material, or alternatively, a multi-pole magnetic assembly may be formed by joining multiple pairs of oppositely polarized magnetic sections linked end to end, such that each magnetic section is magnetically polarized opposite that of each adjacent magnetic section.

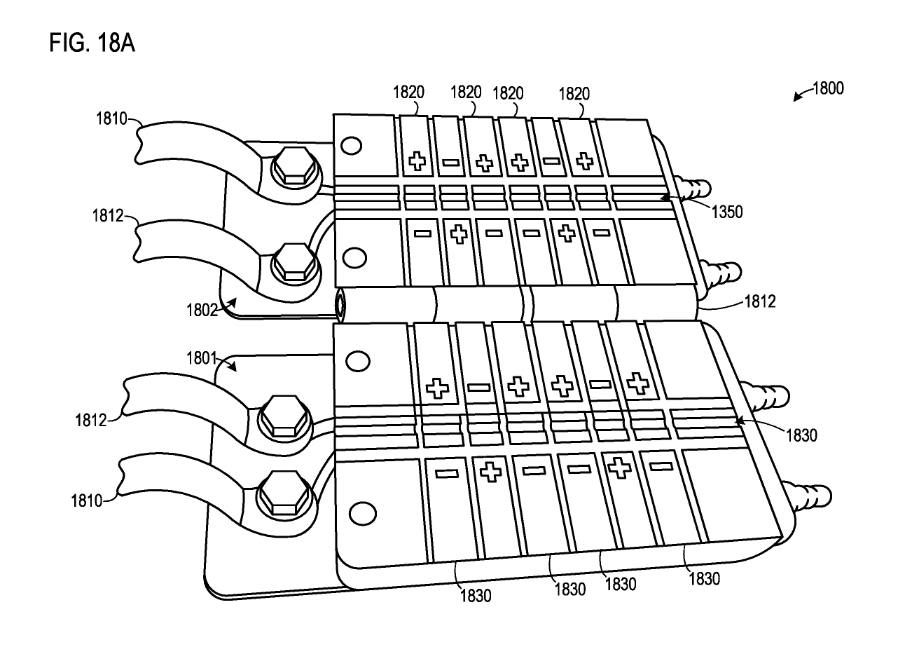

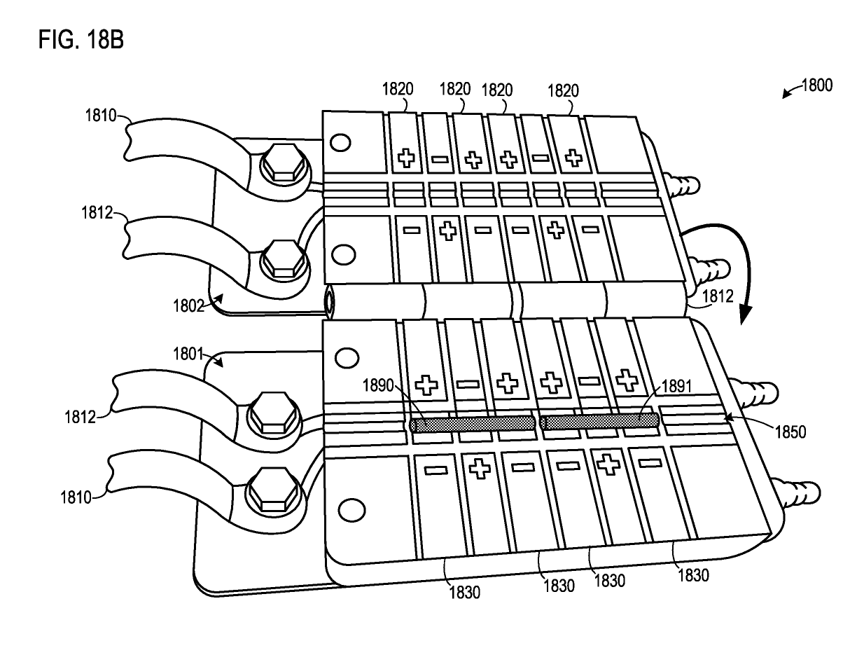

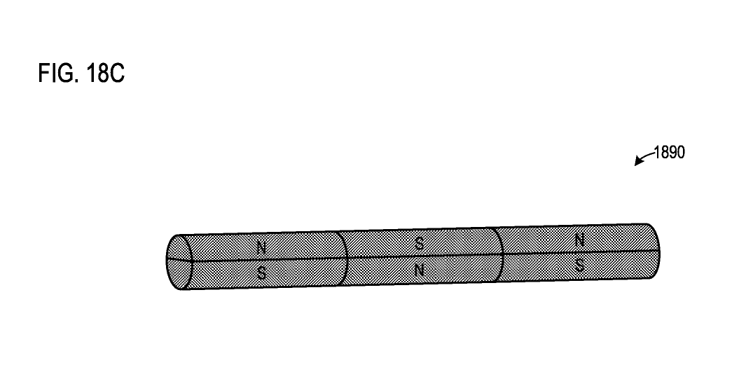

FIG. 18A illustrates a magnetizing apparatus 1800 configured with a bottom plate 1801 and a top plate 1802 configured to create a multi-pole magnetic assembly. As illustrated, top plate 1802 may be pivoted about hinge 1812 until top plate 1802 is positioned directly above bottom plate 1801. In alternative embodiments, top plate 1802 may not be attached to bottom plate 1801 via hinge 1812 and may instead be pressed directly down against bottom plate 1801. As illustrated, each of bottom 1801 and top 1802 plates may include one or more grooves 1850 configured to receive a magnetizable material. Adjacent each groove are magnetizing plates 1820 and 1830 configured to radiate a magnetizable material placed within groove 1850 with magnetic fields of alternating polarity.

FIG. 18B illustrates the magnetizing apparatus 1800 with two magnetizable cylinders 1890 and 1891 in place. Once magnetizable cylinders 1890 and 1891 are in place, top plate 1802 may be pivoted about hinge 1812 onto bottom plate 1801. A current may be provided to cables 1810 and 1812 in order to create positive and negative magnetic fields along magnetizing plates 1820 and 1830, respectively. The magnetizing plates 1820 and 1830 having alternating magnetic polarization may magnetize magnetizable cylinders 1890 and 1891 so as to create a multi-pole magnetic assembly including a first half and second half extending along a longitudinal axis. The first half may include magnetic sections of alternating polarity and the second half may include a corresponding number of magnetic sections each having a polarity opposite that of an adjacent magnetic section in the first half.

FIG. 18C illustrates an exemplary embodiment of a multi-pole magnetic assembly 1890 created using the magnetizing apparatus described in conjunction with FIGS. 18A and 18B. As illustrated, multi-pole magnetic assembly 1890 includes a first half and second half extending along a longitudinal axis. The first half includes three magnetic sections with alternating polarity and the second half includes three corresponding magnetic sections each polarized opposite that of the adjacent magnetic section in the first half.

Those having skill in the art will appreciate that many changes may be made to the details of the above-described embodiments without departing from the underlying principles of the invention. While the principles of this disclosure have been shown in various embodiments, many modifications of structure, arrangements, proportions, elements, materials, shapes, thicknesses, widths, heights, and components, may be used without departing from the principles and scope of this disclosure. These and other changes or modifications are intended to be included within the scope of the present disclosure.

1. A universal connector apparatus utilizing rotatable magnets, comprising:
a first multi-pole magnetic assembly comprising a first half and a second half extending substantially along a longitudinal axis, the first half comprising at least two magnetic sections of alternating polarity and the second half comprising a corresponding number of magnetic sections, each magnetic section in the second half having a polarity opposite that of an adjacent magnetic section in the first half, wherein the first magnetic assembly comprises a unitary piece of magnetic material such that the magnetic sections are integrally formed with one another;
a first connection member connected with the first multi-pole magnetic assembly such that the longitudinal axis of the first magnetic assembly is substantially parallel to at least a portion of a connection edge of the first connection member; and
wherein the first magnetic assembly is configured to rotate about its longitudinal axis in order to align polarities with a second magnetic assembly in order to magnetically link the connection edge of the first connection member to a connection edge of another connection member.

2. The universal connector apparatus of claim 1, wherein the first connection member comprises a first enclosure configured to encase the first magnetic assembly.

3. The universal connector apparatus of claim 2, wherein the first magnetic assembly is configured to rotate about its longitudinal axis within, and with respect to, the first enclosure.

4. The universal connector apparatus of claim 2, wherein the first magnetic assembly is fixedly secured within the first enclosure, such that the first magnetic assembly is configured to be rotated about its longitudinal axis together with the first enclosure with respect to the first connection member.

5. The universal connector apparatus of claim 1, wherein the first magnetic assembly is connected to the first connection member via a connection rod.

6. The universal connector apparatus of claim 1, further comprising:
a second multi-pole magnetic assembly comprising a first half and a second half extending along a longitudinal axis, the first half comprising at least two magnetic sections of alternating polarity and the second half comprising a corresponding number of magnetic sections, each magnetic section in the second half having a polarity opposite that of an adjacent magnetic section in the first half; and
a second connection member connected with the second magnetic assembly, such that the longitudinal axis of the second magnetic assembly is substantially parallel to at least a portion of a connection edge of the second connection member,
wherein the first magnetic assembly and the second magnetic assembly are configured to rotate about their respective longitudinal axes in order to align opposite polarities and magnetically link the connection edge of the second connection member to the connection edge of the first connection member.

7. The universal connector apparatus of claim 6, wherein the second connection member comprises a second enclosure configured to encase the second magnetic assembly.

8. The universal connector apparatus of claim 1, further comprising:
a second multi-pole magnetic assembly comprising a first half and a second half extending along a longitudinal axis, the first half comprising at least two magnetic sections of alternating polarity and the second half comprising a corresponding number of magnetic sections, each magnetic section in the second half having a polarity opposite that of an adjacent magnetic section in the first half; and
a third multi-pole magnetic assembly comprising a first half and a second half extending along a longitudinal axis, the first half comprising at least two magnetic sections of alternating polarity and the second half comprising a corresponding number of magnetic sections, each magnetic section in the second half having a polarity opposite that of an adjacent magnetic section in the first half,
wherein the second magnetic assembly is configured to rotate about its longitudinal axis in order to align opposite polarities and magnetically link a second connection edge of the first connection member to a connection edge of another connection member,
wherein the third magnetic assembly is configured to rotate about its longitudinal axis in order to align opposite polarities and magnetically link a third connection edge of the first connection member to a connection edge of another connection member, and
wherein respective ends of the three connection edges are connected to one another to form a polygon.

9. The universal connector apparatus of claim 1, wherein the first connection member comprises a first enclosure configured to encase the first magnetic assembly, wherein the first enclosure is fixedly secured to the first connection member, and wherein the first magnetic assembly is configured to rotate about its longitudinal axis within, and with respect to, the first enclosure.

10. The universal connector apparatus of claim 9, wherein the first connection member comprises a hollow structure, and
wherein the first enclosure is fixedly secured to the first connection member and encased within the hollow structure.

11. The universal connector apparatus of claim 1, wherein the first connection member comprises a first enclosure positioned within a hollow structure,
wherein the first enclosure is rotatably secured within the hollow structure, such that the first magnetic assembly can be rotated about its longitudinal axis as the first enclosure rotates within the hollow structure.

12. The universal apparatus of claim 11, wherein the first enclosure is substantially cylindrical; and
wherein the first multi-pole magnetic assembly comprises a rectangular prism.

13. The universal connector apparatus of claim 1, wherein the first multi-pole magnetic assembly comprises a first half and a second half extending along a longitudinal axis, the first half comprising three magnetic sections of alternating polarity and the second half comprising three magnetic sections, each of the three magnetic sections in the second half having a polarity opposite that of an adjacent magnetic section in the first half.

14. A universal connector system utilizing rotatable magnets, comprising:
a first multi-pole magnetic assembly comprising a first half and a second half extending along a longitudinal axis, the first half comprising at least two magnetic sections of alternating polarity and the second half comprising a corresponding number of magnetic sections, each magnetic section in the second half having a polarity opposite that of an adjacent magnetic section in the first half;
a first connection member connected with the first magnetic assembly, such that the longitudinal axis of the first magnetic assembly is substantially parallel to at least a portion of a connection edge of the first connection member;
a second multi-pole magnetic assembly comprising a first half and a second half extending along a longitudinal axis, the first half comprising at least two magnetic sections of alternating polarity and the second half comprising a corresponding number of magnetic sections, each magnetic section in the second half having a polarity opposite that of an adjacent magnetic section in the first half;
a second connection member connected with the second magnetic assembly, such that the longitudinal axis of the second magnetic assembly is substantially parallel to at least a portion of a connection edge of the second connection member; and
wherein the first magnetic assembly and the second magnetic assembly are configured to rotate about their respective longitudinal axes in order to align opposite polarities and magnetically link the connection edge of the second connection member to the connection edge of the first connection member.

15. The universal connector system of claim 14, wherein the first magnetic assembly comprises a first enclosure and wherein the second magnetic assembly comprises a second enclosure, wherein the first and second enclosures are configured to encase the first and second magnetic assemblies, respectively, such that the first and second magnetic assemblies can rotate about their respective longitudinal axes within, and with respect to, the first enclosure and the second enclosure, respectively.

16. The universal connector system of claim 14, wherein the first connection member comprises a first plurality of multi-pole magnetic assemblies, each magnetic assembly comprising a first half and a second half extending along a longitudinal axis, the first half comprising at least two magnetic sections of alternating polarity and the second half comprising a corresponding number of magnetic sections, each magnetic section having a polarity opposite that of an adjacent magnetic section in the first half, and
wherein the first connection member comprises a first plurality of connection edges each having a pair of opposite ends, wherein the longitudinal axis of each of the first plurality of multi-pole magnetic assemblies is substantially parallel to at least a portion of a connection edge of the first plurality of connection edges,
wherein each end of each of the first plurality of connection edges is connected to an end of another of the first plurality of connection edges, such that the interconnected connection edges forms a first polygon,
wherein the second connection member comprises a second plurality of multi-pole magnetic assemblies, each magnetic assembly comprising a first half and a second half extending along a longitudinal axis, the first half comprising at least two magnetic sections of alternating polarity and the second half comprising a corresponding number of magnetic sections, each magnetic section having a polarity opposite that of an adjacent magnetic section in the first half,
wherein the second connection member comprises a second plurality of connection edges each having a pair of opposite ends, wherein the longitudinal axis of each of the second plurality of multi-pole magnetic assemblies is substantially parallel to at least a portion of a connection edge of the second plurality of connection edges,
wherein each end of each of the second plurality of connection edges is connected to one end of another of the second plurality of connection edges, such that the interconnected connection edges forms a second polygon,
wherein each of the first and second pluralities of magnetic assemblies is configured to rotate about its longitudinal axis, and
wherein at least a portion of an outer perimeter of the first polygon is configured to be magnetically linked to at least a portion of an outer perimeter of the second polygon.

17. The universal connector system of claim 16, wherein the first plurality of connection edges comprises three connection edges, such that the first polygon comprises a triangular shape.

18. A universal connector system comprising:
a first plurality of multi-pole magnetic assemblies, each magnetic assembly comprising a first half and a second half extending along a longitudinal axis, the first half comprising at least two magnetic sections of alternating polarity and the second half comprising a corresponding number of magnetic sections, each magnetic section having a polarity opposite that of an adjacent magnetic section in the first half;
a first plurality of connection edges, each connection edge comprising a first end and a second end, wherein the first plurality of connection edges together form a first polygon;
a first plurality of enclosures, each of the enclosures being positioned substantially parallel to one of the first plurality of connection edges, and each of the enclosures being configured to encase at least one of the first plurality of multi-pole magnetic assemblies to allow the multi-pole magnetic assemblies to rotate about their respective longitudinal axes;
a second plurality of multi-pole magnetic assemblies, each magnetic assembly comprising a first half and a second half extending along a longitudinal axis, the first half comprising at least two magnetic sections of alternating polarity and the second half comprising a corresponding number of magnetic sections, each magnetic section having a polarity opposite that of an adjacent magnetic section in the first half;
a second plurality of connection edges, each connection edge comprising a first end and a second end, wherein the second plurality of connection edges together form a second polygon;
a second plurality of enclosures, each of the enclosures being positioned substantially parallel to one of the second plurality of connection edges, and each of the enclosures being configured to encase at least one of the second plurality of magnetic assemblies to allow the multi-pole magnetic assemblies to rotate about their respective longitudinal axes; and
wherein an outer perimeter of the first polygon is configured to be magnetically linked to an outer perimeter of the second polygon.

19. The universal connector system of claim 18, wherein the first plurality of connection edges comprises three connection edges, such that the first polygon comprises a triangular shape; and
wherein the second plurality of connection edges comprises four connection edges, such that the second polygon comprises a rectangular shape.

20. The universal connector system of claim 18, wherein at least a subset of the multi-pole magnetic assemblies are configured to rotate with respect to their respective enclosures.

21. The universal connector system of claim 20, wherein at least a subset of the multi-pole magnetic assemblies are substantially cylindrical in shape.
